(19) United States
(12) Patent Application Publication
(10) Pub. No.: US 2006/0026415 A1
(43) Pub. Date: Feb. 2, 2006

(54) Method of updating a portion BIOS

(75) Inventor: Chih-Wei Chen, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/900,100

(22) Filed: Jul. 28, 2004

(51) Int. Cl. G06F 9/24

(52) U.S. Cl. 713/2

(57) ABSTRACT

The present invention is to provide a method of updating a portion of BIOS, which includes an updating software that, when being executed for an image file, performing steps of determining operation information of the image file belonging to which hardware component or standard; and directly rewriting the operation information in a corresponding memory block of memory of BIOS for partially updating BIOS, enabling a user to directly obtain a new image file of binary codes provided by a hardware manufacturer or standard setting organization and directly update a portion of BIOS associated with the hardware or standard without having to wait an immediately editing of the updating program of BIOS by the motherboard manufacturer.

### FIELD OF THE INVENTION

The present invention relates to BIOS updating and more particularly to a method of updating a portion of BIOS with improved characteristics.

### BACKGROUND OF THE INVENTION

BIOS (Basic Input Output System) of an electronic product is embedded software. BIOS comprises a set of procedures in the form of firmware stored on a ROM (e.g., EPROM, EEPROM, or FLASH) chip inside an electronic product. BIOS is responsible for driving devices, controlling processes, interface management, application programs manipulation, etc. As compared to OS (operating system) or software, it is more closely related to hardware. Routines of BIOS handle CPU (central processing unit) control, memory management, setting of power on sequence of components, etc. BIOS is critical to the maximum performance of hardware. An arbitrary change of BIOS of electronic product may cause an unsuccessful start in a next power on of the electronic product.

BIOS of a computer is adapted to control CPU and chips and input-output (IO) functions of various peripheral devices (e.g., printer, mouse, keyboard, hard disk drive, and floppy disk drive). BIOS is activated when BIOS is powered on. Immediately next, BIOS determines whether all hardware components are ready. Next, BIOS loads OS from hard disk drive into RAM (random access memory). As such, both OS and application programs do not have to record details (e.g., hardware component addresses) of coupled 10 devices. Updating of BIOS rather than OS and application programs is sufficient if there is data change. In addition, newer hardware components and standards are available in a faster pace. After enabling BIOS, the motherboard of a computer cannot correctly identify a new type CPU, cannot support a newer high capacity hard disk drive, and/or cannot be compatible with sound card, video adapter, or network card if a new component is installed in the computer. Updating BIOS is necessary if the motherboard is required to support a new function (e.g., a motherboard not supplying CPU core voltage is changed into one supplying CPU core voltage). In other words, preferably, update BIOS for obtaining a new version BIOS (i.e., updated BIOS). This is because updating BIOS of the motherboard will improve compatibility, increase computer performance, and increase reliability.

Moreover, a specific updating program is required to update BIOS. Such updating program is provided by a motherboard manufacturer and a latest version thereof can be downloaded from a website of the manufacturer. Updating BIOS can be achieved by sequentially performing steps in executing the updating program. Additionally, a variety of binary codes are available from hardware manufacturers or standard setting organizations. Such binary codes are required to edit by a motherboard manufacturer by means of an editing program so as to create all routines of BIOS. The routines comprise information regarding operations of various hardware components or standards. Responsive to enabling BIOS, a computer may correctly operate the various hardware components or standards based on the operation information. Hence, a motherboard manufacturer must update binary codes related to corresponding hardware components or standards into new binary codes in response to updating binary codes by any hardware manufacturers or standard setting organizations. Finally, edit all binary codes again to create an updating program of new BIOS.

However, the prior art technique suffered from several disadvantages. For example, the editing process performed by the updating program of the new BIOS is a time consuming one. Also, the updating program may contain many errors if there are erroneous binary codes due to typographical errors or erroneous operations of a compiler. As a result, an updated BIOS is not available. This can bring a lot of trouble to the manufacturers.

Additionally, updating BIOS, as compared to updating any of other software programs, is relatively difficult because BIOS is stored on a ROM chip inside a computer. Also, the updating of BIOS may fail if updating version of BIOS is incorrect or power outage is occurred during updating. As an end, the computer may not be powered on. Fortunately, there are techniques available for solving the problem. However, such cannot be done by most ordinary users. Thus, it is desirable to provide a novel method of updating BIOS in a minimum time and eliminating the prior process of editing all portions of BIOS again.

### SUMMARY OF THE INVENTION

After considerable research and experimentation, a method of updating a portion of BIOS according to the present invention has been devised.

It is an object of the present invention to provide a method of updating a portion of BIOS, the method including an updating software which, when executed for an image file, performs steps comprising determining operation information of the image file belonging to which hardware component or standard; and directly rewriting the operation information in a corresponding memory block of memory of BIOS for partially updating BIOS. In such a manner, a user can directly obtain a new image file of binary codes provided by a hardware manufacturer or standard setting organization, and directly update a portion of BIOS associated with the hardware or standard without having to wait an immediately editing of the updating program of BIOS by the motherboard manufacturer.

In another object of the present invention, after providing the updating software to a user and updating new binary codes of the operation information, the motherboard manufacturer is not required to immediately edit the updating program of BIOS with respect to a specific hardware of standard so as to decrease the number of errors occurred during BIOS editing and greatly reduce the cost of editing BIOS again.

The above and other objects, features and advantages of the present invention will become apparent from the following detailed description taken with the accompanying drawings.

### BRIEF DESCRIPTION OF THE DRAWINGS

FIG. 1 is a flow chart of updating software according to the invention;

FIG. 2 depicts a file format of image file according to the invention;

FIG. 3 depicts an updating reference table according to the invention;

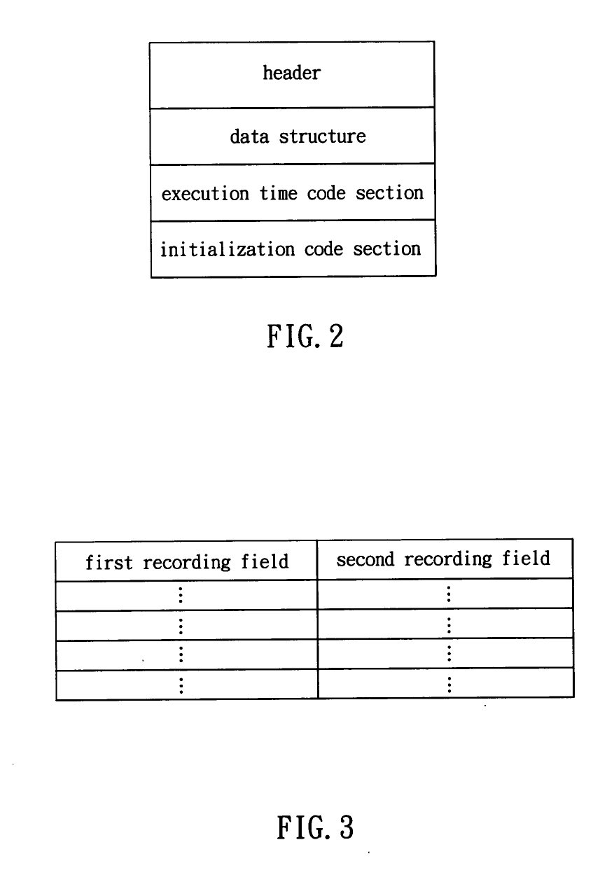

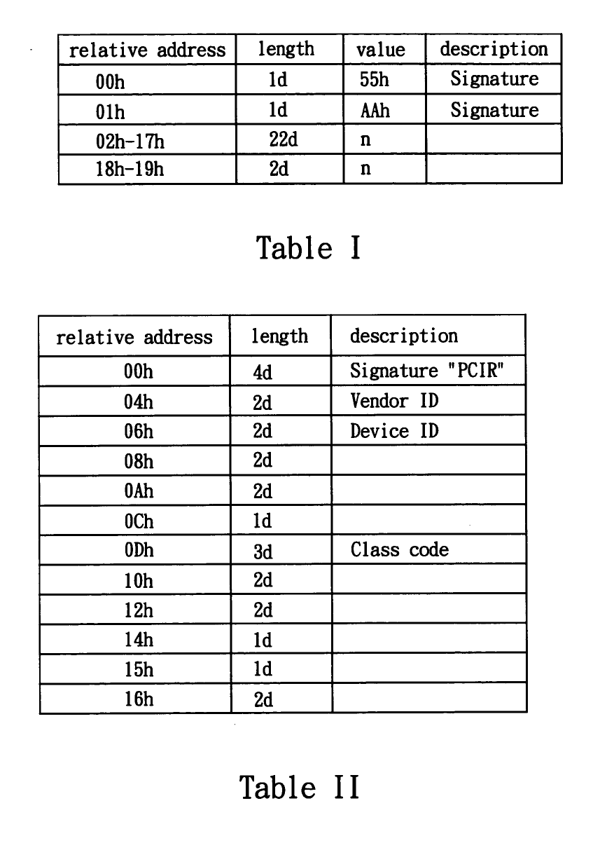

Table I depicts fields and data in the data structure shown in FIG. 2 according to the invention; and

Table II depicts fields and data in the header shown in FIG. 2 according to the invention.

### DETAILED DESCRIPTION OF THE PREFERRED EMBODIMENTS

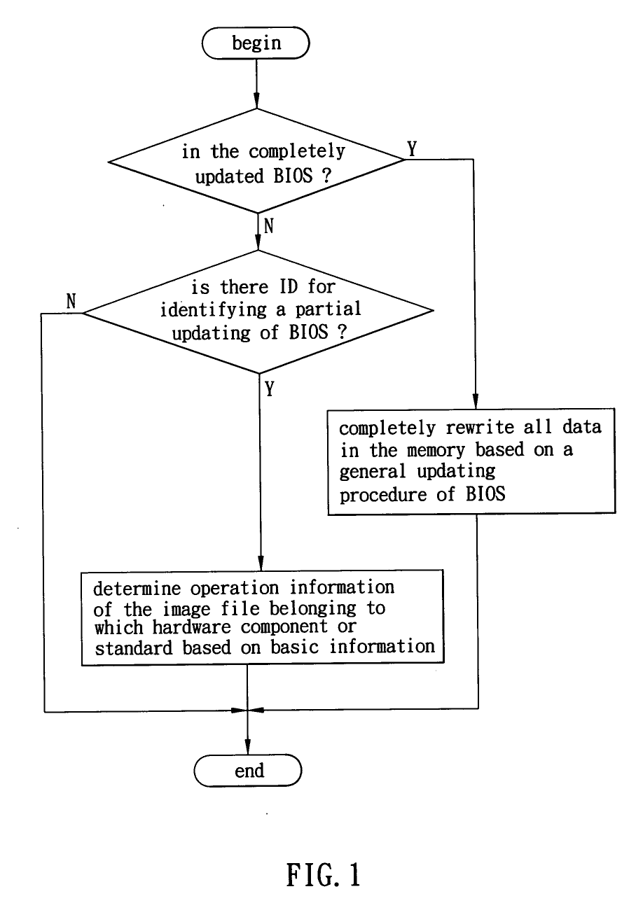

Referring to FIG. 1, there is shown a process of updating a portion of BIOS in accordance with the invention. The process (i.e., image file) is executed by an updating software for determining operation information of the image file belonging to which hardware component or standard. Further, search memory (e.g., Flash ROM) of BIOS in order to find a corresponding memory block with the operation information to be stored therein. Next, store the operation information in the corresponding memory block for partially updating BIOS. In such a manner, a motherboard manufacturer does not have to immediately edit the updating program of BIOS again after updating binary codes of operation information by any hardware component or standard. This can avoid errors from occurring during editing new BIOS. Moreover, a user can obtain updated binary codes from hardware manufacturers or standard setting organizations. Next, execute the updating software to directly update a portion of BIOS. As a result, it is possible of update BIOS in a substantially real time manner without waiting a motherboard manufacturer to edit the updating program of BIOS again.

After a user obtaining an image file of updated BIOS, it should prevent the user from being unable to update by running the updating software. Alternatively, it should prevent the updating software from erroneously taking an image file of completely updated BIOS as an image file of partially updated BIOS in a subsequent processing. Otherwise, the updated BIOS may fail to start the power on of a computer. Thus, in one preferred embodiment of the invention, the updating software may determine whether the image file belongs to the completely updated BIOS or the partially updated BIOS prior to determining operation information of the image file belonging to which hardware component or standard. If it is determined that the image file belongs to the completely updated BIOS by the updating software, the updating software may completely rewrite all data in the memory based on a general updating procedure of BIOS. Otherwise, if it is determined that the image file belongs to the partially updated BIOS by the updating software, the updating software may next perform the step of determining operation information of the image file belonging to which hardware component or standard.

In the embodiment, there is at least one ID for identifying a partial updating of BIOS in the image file of the partially updated BIOS. Each of the ID for identifying a partial updating of BIOS is stored in a unique data address of the image file such that the updating software may determine whether there is any ID for identifying a partial updating of BIOS in the image file during the process of processing an image file by the updating software. If yes, it is determined that the image file belongs to the partially updated BIOS. Next, a step of determining operation information of the image file belonging to which hardware component or standard is executed. Otherwise (i.e., it is determined that the image file does not belong to the partially updated BIOS), completely rewrite all data in the memory based on a general updating procedure of BIOS.

In the embodiment, in the image file of the partially updated BIOS, there is further provided basic information of the hardware component or standard associated therewith. The basic information is comprised of vendor ID, the hardware component ID (i.e., device ID) or standard ID, class code, etc. As such, the updating software may determine the image file belonging to which hardware component or standard based on the basic information. Next, store the operation information in the corresponding memory block for finishing the task of partially updating BIOS.

Referring to FIG. 2, in the embodiment the IDs for identifying a partial updating of BIOS are stored in different relative addresses of a header of an image file of the partially updated BIOS. Also, fields of the IDs for identifying a partial updating of BIOS and data thereof are tabulated in table I. Referring to table I again, the basic information is stored in a data structure of the image file of the partially updated BIOS.

For enabling the updating software to correctly store the operation information of the image file in a corresponding memory block by determining the image file belonging to which hardware component or standard based on the basic information, in the invention the updating software comprises an updating reference table. The updating reference table comprises a first recording field for recording a plurality of hardware components or standards, and a second recording field for recording a plurality of corresponding memory blocks associated with the hardware components or standards in which data in each row of the first recording field corresponds to data in each row of the second recording field. As such, after determining the image file belonging to which hardware component or standard based on the basic information by the updating software, the updating software then may search the first recording field of the updating reference table for finding matched hardware component or standard. Next, find a memory block recorded in the second recording field corresponding to the first recording field. Finally, store or rewrite the operation information of the image file in the memory block.

In view of the above, the updating software is able to correctly store image files of different hardware components or standards in specific memory blocks without rewriting the whole memory, thereby solving the problems (e.g., time consuming editing process, erroneous binary codes due to typographical errors in editing, or erroneous operations of a compiler)) associated with the well known updating program of BIOS. Moreover, a user does not need to wait the motherboard manufacturer to provide an updating program of updated BIOS. In addition, there is no need of rewriting the whole memory, resulting in a decrease of errors occurred in the process of rewriting memory.

While the invention herein disclosed has been described by means of specific embodiments, numerous modifications and variations could be made thereto by those skilled in the art without departing from the scope and spirit of the invention set forth in the claims.

What is claimed is:

1. A method of updating a portion of BIOS, the method including an updating software which, when executed for an image file, performs steps comprising:
determining operation information of the image file belonging to which hardware component or standard;
searching memory of BIOS for finding a corresponding memory block with the operation information to be stored therein; and
storing the operation information in the corresponding memory block for partially updating BIOS.

2. The method of claim 1, wherein the updating software is adapted to determine whether the image file belongs to a completely updated BIOS prior to determining the operation information of the image file belonging to which hardware component or standard; and if it is determined that the image file belongs to the completely updated BIOS by the updating software, the updating software is adapted to completely rewrite all data in the memory based on a general updating procedure of BIOS.

3. The method of claim 2, wherein the updating software is adapted to determine whether the image file belongs to a partially updated BIOS prior to determining the operation information of the image file belonging to which hardware component or standard; and if it is determined that the image file belongs to the partially updated BIOS by the updating software, the updating software is adapted to perform the step of determine the operation information of the image file belonging to which hardware component or standard.

4. The method of claim 3, wherein the image file of the partially updated BIOS comprises at least one ID for identifying a partial updating of BIOS, each of the ID for identifying a partial updating of BIOS being stored in a unique data address of the image file such that the updating software is adapted to determine whether there is any ID for identifying a partial updating of BIOS in the image file during a process of processing the image file by the updating software; and if it is determined that the image file belongs to the partially updated BIOS, the updating software is adapted to perform the step of determining the operation information of the image file belonging to which hardware component or standard.

5. The method of claim 3, wherein if it is determined that the image file does not contain any ID for identifying a partial updating of BIOS the updating software is adapted to perform the step of completely rewriting all data in the memory based on a general updating procedure of BIOS.

6. The method of claim 4, wherein the image file of the partially updated BIOS further comprises basic information of the hardware component or the standard associated therewith, the basic information being comprised of a vendor ID, a hardware component ID or a standard ID, and a class code such that the updating software is adapted to determine the image file belonging to which hardware component or standard based on the basic information, and store the operation information in the corresponding memory block.

7. The method of claim 4, wherein each ID for identifying a partial updating of BIOS is stored in different relative addresses of a header of an image file of the partially updated BIOS, and values of the IDs for identifying a partial updating of BIOS are different.

8. The method of claim 6, wherein the basic information is stored in a data structure of the image file of the partially updated BIOS.

9. The method of claim 1, wherein the updating software comprises an updating reference table including a first recording field for recording a plurality of hardware components or standards, and a second recording field for recording a plurality of corresponding memory blocks associated with the hardware components or the standards, and wherein data in each row of the first recording field corresponds to data in each row of the second recording field such that after determining the image file belonging to which hardware component or standard based on the basic information by the updating software, the updating software is adapted to search the first recording field of the updating reference table for finding the matched hardware component or standard, find a memory block recorded in the second recording field corresponding to the first recording field, and store or rewrite the operation information of the image file in the memory block.
